(19) United States
(12) Patent Application Publication
(10) Pub. No.: US 2012/0123729 A1
(43) Pub. Date: May 17, 2012

(54) ELECTRONIC DEVICE AND METHOD OF CONVERTING MEASUREMENT PROGRAMS

(75) Inventors: CHIH-KUANG CHANG, Tu-Cheng (TW); XIN-YUAN WU, Shenzhen City (CN); JIN-GANG RAO, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/244,620

(22) Filed: Sep. 25, 2011

(30) Foreign Application Priority Data
Nov. 12, 2010 (CN) 201010541521.X

(51) Int. Cl. G06F 15/00

(52) U.S. Cl. 702/127

(57) ABSTRACT

A method of converting a measurement program A of a first measurement machine to a measurement program B which is usable to a second measurement machine B inserts the measurement information of the measurement program A into a measurement program template A′ of the first measurement machine to generate a measurement program template A1′. The method further substitutes special character in a measurement program template B′ of the second measurement machine using the measurement information in the measurement program template A1′ to generate the measurement program B.

### BACKGROUND

1. Technical Field

Embodiments of the present disclosure relate to systems and methods of data conversion, and more particularly to an electronic device and a method of converting measurement programs of measurement machines.

2. Description of Related Art

Measurement machines can be used to measure physical dimensions and geometric tolerances of a product. For the purpose of measuring physical dimensions and geometric tolerances of a product with high precision and high speed, the measurement machine is programmed using a measurement program. Usually, measurement programs for different measurement machines have different formats. For example, the measurement programs of different measurement machines are programmed in different program languages. Thus, in order to measure the same product by utilizing different measurement machines, a user needs to program for each of the measurement machines. In this way, it is inconvenient and time-consuming for the user to reprogram the measurement machines.

### BRIEF DESCRIPTION OF THE DRAWINGS

FIG. 1 is a block diagram of one embodiment of an electronic device including a measurement program converting system.

FIG. 2 is a block diagram of one embodiment of the measurement program converting system included in the electronic device of FIG. 1.

FIG. 3 is a flowchart of one embodiment of a method of converting measurement programs using the electronic device of the FIG. 1.

### DETAILED DESCRIPTION

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

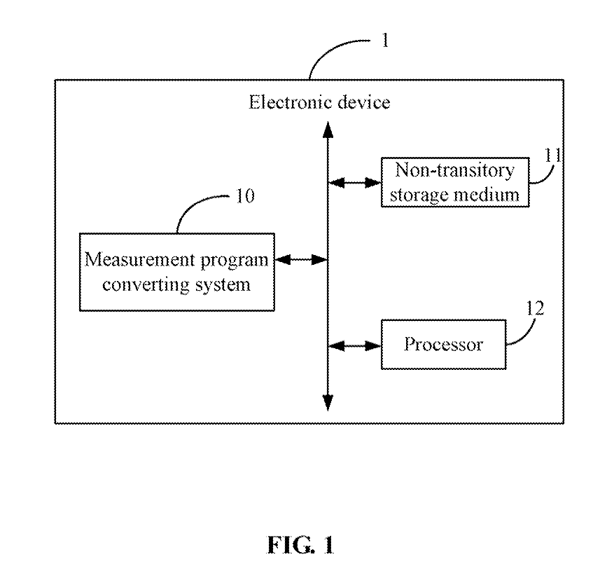

FIG. 1 is a block diagram of one embodiment of an electronic device 1 including a measurement program converting system 10. In the embodiment, the electronic device 1 further includes a non-transitory storage medium (hereinafter, storage medium for short) 11, and at least one processor 12. The measurement program converting system 10 may be used to convert a measurement program A of a first measurement machine into a measurement program B having a different format with the measurement program A, to be usable for a second measurement machine. Using the measurement program converting system 10, a user does not need to program for each of different measurement machines when measuring the same product by utilizing the measurement machines. Depending on the embodiment, the storage medium 11 may be a hard disk drive, a compact disc, a digital video disc, a tape drive or other suitable storage medium.

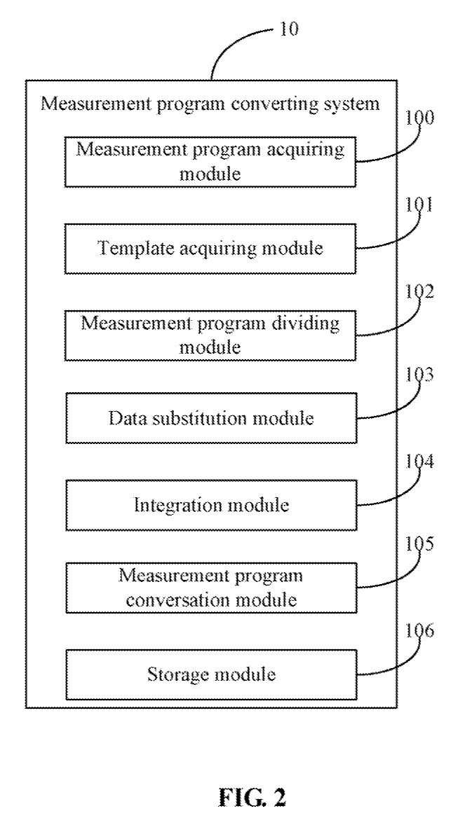

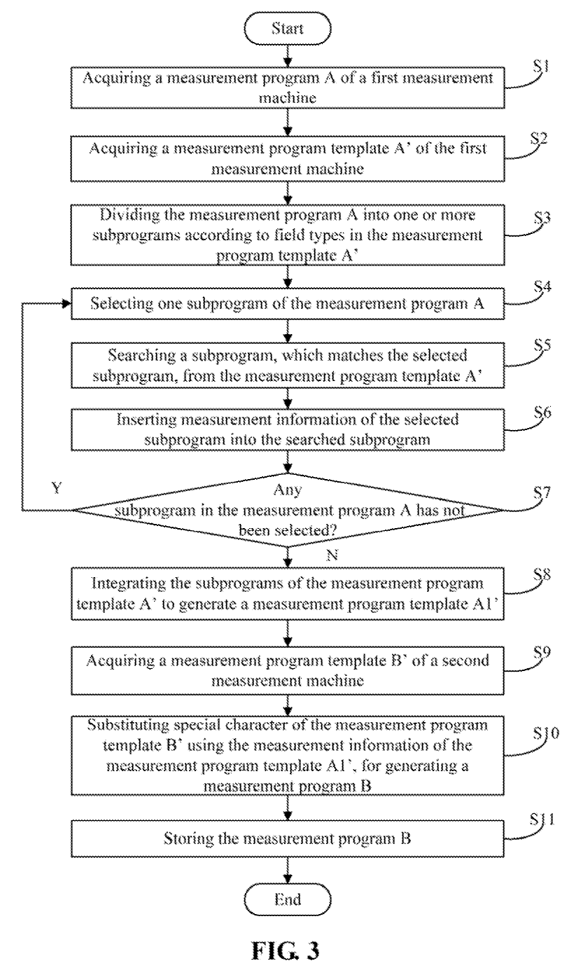

FIG. 2 is a block diagram of one embodiment of the measurement program converting system 10 of the electronic device 1. In one embodiment, the measurement program converting system 10 may include one or more modules, for example, a measurement program acquiring module 100, template acquiring module 101, a measurement program dividing module 102, a data substitution module 103, an integration module 104, a measurement program conversation module 105, and a storage module 106. The one or more modules 100-106 may comprise computerized code in the form of one or more programs that are stored in the storage medium 11. The computerized code includes instructions that are executed by the at least one processor 12 to provide below mentioned functions of the one or more modules 100-106 illustrated in FIG. 3.

FIG. 3 is a flowchart of one embodiment of a method of converting measurement programs using the electronic device 1 of the FIG. 1. Depending on the embodiment, additional blocks may be added, others removed, and the ordering of the blocks may be changed.

In block S1, the measurement program acquiring module 100 acquires a measurement program A of the first measurement machine from the storage medium 11. In one embodiment, the measurement program A includes at least one subprogram. Each subprogram is constituted by one field type or a couple of field types. In one example, the measurement program A may be:
Measure(ID:=“PT3”, Type:=MPoint, X:=3.4678, Y:=2.1224, Z:=0.0000)
   TPoint(X:=6.9084, Y:=1.1078, A:=−0.2222, L:=50, D:=BlackToWhite, F:=42, G:=102)
EndMea( )
Construct(ID:=“PT4”, FType:=MPoint, CType:=MidPoint, Labels:=“PT2, PT3”)
OutPut(T:=X, D:=“1”, L1:=“PT4”, N:=“3.4500”, U:=“0.1000”, L:=“−0.1000”). In the above example, “Construct” and “Output” are field types, and “Measure” and “EndMea” is a couple of field types.

In block S2, the template acquiring module 101 acquires a measurement program template A′ of the first measurement machine from the storage medium 11. In one embodiment, the measurement program template A′ is similar to the measurement program A, but substitutes measurement information in the measurement program A with a special character, like “$Format.” Thus, the measurement program template A′ also includes at least one subprogram, each of which is constituted by one field type or a couple of field types. The measurement program template A′ may be:
Measure(ID:=“$Format0”, Type:=$Format1, X:=$Format2, Y:=$Format3, Z:=$Format4)
   TPoint(X:=$Format0, Y:=$Format1, A:=$Format2, L:=$Format3, D:=$Format4, F:=$Format5, G:=$Format6)
EndMea( )
Construct(ID:=“$Format0”, FType:=$Format1, CType:=$Format2, Labels:=“$Format3”)
OutPut(T:=$Format0, D:=“$Format1″”, L1:=“$Format2”, N:=“$Format3”, U:=“$Format4”, L:=“$Format5”).

In block S3, the measurement program dividing module 102 divides the measurement program A into one or more subprograms according to the field types in the measurement program template A′. According the above example, the measurement program A is divided into three subprograms as follows:

the first subprogram:
Measure(ID:=“PT3”, Type:=MPoint, X:=3.4678, Y:=2.1224, Z:=0.0000)
   TPoint(X:=6.9084, Y:=1.1078, A:=−0.2222, L:=50, D:=BlackToWhite, F:=42, G:=102)
EndMea( );
   the second subprogram:
Construct(ID:=“PT4”, FType:=MPoint, CType:=MidPoint, Labels:=“PT2, PT3”); and
   the third subprogram:
OutPut(T:=X, D:=“1”, L1:=“PT4”, N:=“3.4500”, U:=“0.1000”, L:=“−0.1000”).

In block S4, the data substitution module 103 selects one of the subprograms from the measurement program A. In one embodiment, the selection is in sequence.

In block S5, the data substitution module 103 searches a subprogram, which matches the selected subprogram of the measurement program A, from the measurement program template A′. In one embodiment, the match means the searched subprogram from the measurement program template A′ and the selected subprogram of the measurement program A have the same field type.

In block S6, the data substitution module 103 inserts the measurement information of the selected subprogram of the measurement program A into corresponding positions of the special character “$Format” in the searched subprogram of the measurement program template A′. For example, if the selected subprogram of the measurement program A is:
Construct(ID:=“PT4”, FType:=MPoint, CType:=MidPoint, Labels:=“PT2, PT3”), and the searched subprogram of the measurement program template A′ is:
Construct(ID:=“$Format0”, FType:=$Format1, CType:=$Format2, Labels:=“$Format3”), the data substitution module 103 inserts the measure information “PT4” of the selected subprogram into the position of the special character “$Format0”, inserts the measure information MPoint into the position of the special character $Format1, for example.

In block S7, the data substitution module 103 determines if there is any subprogram in the measurement program A that has not been selected, and repeats the operations in blocks S4˜S6 if there is any subprogram in the measurement program A that has not been selected. If all subprograms in the measurement program A have been selected, block S8 is implemented.

In block S8, the integration module 104 integrates the subprograms, the special character “$Format” in which have been substituted, of the measurement program template A1′, to generate a measurement program template A1′.

In block S9, the template acquiring module 101 acquires a measurement program template B′ of the second measurement machine from the storage medium 11. In one embodiment, the measurement program template B′ also includes at least one subprogram, each of which is constituted by one field type or a couple of field types and uses a special character “$Format” to represent measurement information. The measurement program template B′ may be programmed using different program languages with the measurement program template A′. It may be understood that, different program languages have corresponding relations. In one example, the measurement program template B′ of the second measurement machine may be:
Measure.$Format0 Label:=“$Format1”
Stage.MoveTo X:=$Format0, Y=$Format1, Z:=$Format2
Light.Color=$Format0
PointTool.Run X:=$Format0, Y:=$Format1, Z:=$Format2, L:=$Format3, Angle:=$Format4
Measure.EndMeas.
   In the above example, the character “Lable” corresponds to the character “ID” in the measurement program template A′, the character “Angle” corresponds to the character “A” in the measurement program template A′, for example.

In block S10, the measurement program conversation module 105 substitutes the special character “$Format” in the measurement program template B′ using the measurement information in the measurement program template A1′ according to corresponding relation of different program languages, for generating a measurement program B which is usable for the second measurement machine. According to the above examples, the measurement program B may be:
Measure.Point Label:=“PT3”
Stage.MoveTo X:=3.4678, Y:=2.1224, Z:=0.0000 Light.Color=BlackToWhite
PointTool.Run X:=6.9084, Y:=1.1078, Z:=0.0000, L:=50, Angle:=−0.2222
Measure.EndMeas.

In block S11, the storage module 106 stores the measurement program B into the storage medium 11.

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A computerized-method of converting measurement programs, comprising:
acquiring a measurement program A of a first measurement machine from a storage medium;
acquiring a measurement program template A′ of the first measurement machine and a measurement program template B′ of a second measurement machine from the storage medium, wherein measurement program template A′ and the measurement program template B′ uses a special character to represent measurement information, and the measurement program template A′ and the measurement program template B′ are programmed using different program languages;
dividing the measurement program A into one or more subprograms according to field types in the measurement program template A′;
selecting one of the subprograms from the measurement program A one by one;
searching a subprogram, which matches the selected subprogram of the measurement program A, from the measurement program template A′;
inserting the measurement information of the selected subprogram of the measurement program A into positions of the special character in the searched subprogram of the measurement program template A′;
integrating the subprograms of the measurement program template A1′ to generate a measurement program template A1′;
substituting the special character in the measurement program template B′ using the measurement information in the measurement program template A1′ according to corresponding relation of the different program languages, to generate a measurement program B; and
storing the measurement program B into the storage medium.

2. The method according to claim 1, wherein the measurement program template A′ is generated by substituting measurement information in the measurement program A with the special character.

3. The method according to claim 1, wherein the selection is in sequence.

4. The method according to claim 1, wherein the match means the searched subprogram from the measurement program template A′ and the selected subprogram of the measurement program A have the same field type.

5. An electronic device, comprising:
a non-transitory storage medium;
at least one processor; and
one or more modules that are stored in the non-transitory storage medium; and are executed by the at least one processor, the one or more modules comprising instructions:
to acquire a measurement program A of a first measurement machine, a measurement program template A′ of the first measurement machine, and a measurement program template B′ of a second measurement machine from a storage medium, wherein measurement program template A′ and the measurement program template B′ uses a special character to represent measurement information, and the measurement program template A′ and the measurement program template B′ are programmed using different program languages;
to divide the measurement program A into one or more subprograms according to field types in the measurement program template A′;
to select one of the subprograms from the measurement program A one by one;
to search a subprogram, which matches the selected subprogram of the measurement program A, from the measurement program template A′;
to insert the measurement information of the selected subprogram of the measurement program A into positions of the special character in the searched subprogram of the measurement program template A′;
to integrate the subprograms of the measurement program template A1′ in order to generate a measurement program template A1′;
to substitute the special character in the measurement program template B′ using the measurement information in the measurement program template A1′ according to corresponding relation of the different program languages, to generate a measurement program B; and
to store the measurement program B into the storage medium.

6. The electronic device according to claim 5, wherein the measurement program template A′ is generated by substituting measurement information in the measurement program A with the special character.

7. The electronic device according to claim 5, wherein the selection is in sequence.

8. The electronic device according to claim 5, wherein the match means the searched subprogram from the measurement program template A′ and the selected subprogram of the measurement program A have the same field type.

9. A non-transitory storage medium having stored thereon instructions that, when executed by a processor of an electronic device, causes the processor to perform a method of converting measurement programs, the method comprising:
acquiring a measurement program A of a first measurement machine from a storage medium;
acquiring a measurement program template A′ of the first measurement machine and a measurement program template B′ of a second measurement machine from the storage medium, wherein measurement program template A′ and the measurement program template B′ uses a special character to represent measurement information, and the measurement program template A′ and the measurement program template B′ are programmed using different program languages;
dividing the measurement program A into one or more subprograms according to field types in the measurement program template A′;
selecting one of the subprograms from the measurement program A one by one;
searching a subprogram, which matches the selected subprogram of the measurement program A, from the measurement program template A′;
inserting the measurement information of the selected subprogram of the measurement program A into positions of the special character in the searched subprogram of the measurement program template A′;
integrating the subprograms of the measurement program template A1′, to generate a measurement program template A1′;
substituting the special character in the measurement program template B′ using the measurement information in the measurement program template A1′ according to corresponding relation of the different program languages, to generate a measurement program B; and
storing the measurement program B into the storage medium.

10. The non-transitory storage medium according to claim 9, wherein the measurement program template A′ is generated by substituting measurement information in the measurement program A with the special character.

11. The non-transitory storage medium according to claim 9, wherein the selection is in sequence.

12. The non-transitory storage medium according to claim 11, wherein the match means the searched subprogram from the measurement program template A′ and the selected subprogram of the measurement program A have the same field type.
